(19) United States
(12) Patent Application Publication
(10) Pub. No.: US 2019/0068305 A1
(43) Pub. Date: Feb. 28, 2019

(54) BROADCASTING COMMUNICATION SYSTEM, BROADCASTING RELAY DEVICE AND BROADCASTING RELAY METHOD

(71) Applicant: Uniband Electronic Corp., Hsinchu (TW)

(72) Inventor: Huan-Ping SU, Hsinchu City (TW)

(21) Appl. No.: 15/692,292

(22) Filed: Aug. 31, 2017

(51) Int. Cl. H04H 20/08; H04H 20/18; H04H 20/61; H04H 20/71

(52) U.S. Cl. CPC H04H 20/08; H04H 20/71; H04H 20/61; H04H 20/18

(57) ABSTRACT

A broadcasting communication system includes a plurality of first electronic devices, a plurality of second electronic devices and at least one broadcasting relay device. The plurality of first electronic devices and the plurality of second electronic devices are communicatively isolated. The broadcasting relay device receives a first broadcast packet from the plurality of first electronic devices to broadcast a second broadcast packet to the plurality of second electronic devices, wherein the second broadcast packet includes a broadcast data of the first broadcast packet. Thus, the plurality of first electronic devices and the plurality of second electronic devices can communicatively connected to each other through the broadcasting relay device, and a broadcast storm will not be formed. Herewith, a broadcasting relay device and a broadcasting relay method are also disclosed.

### BACKGROUND OF THE INVENTION

### 1. Field of the Invention

The present invention relates to a broadcasting communication system, a broadcasting relay device and a broadcasting relay method, and more particularly to a broadcasting communication system, a broadcasting relay device and a broadcasting relay method that may inhibit a broadcast storm.

### 2. Description of the Prior Art

The traditional wireless communication utilizes the star, tree or mesh architecture to communicate. The star communication architecture is simpler, but the communication range thereof is smaller. The tree communication architecture can cover a wider range, but the packet transmission path should be specified, which leads to the more complicated hardware installation and maintenance. The mesh communication architecture has an easy installation, and for example, the Zigbee or Bluetooth communication system utilizes the mesh communication architecture to deploy the wireless communication network.

Compared with the unicast communication method, the broadcast has advantages, such as a better communication reliability and no need to manage the communication addresses of various electronic devices. However, in a large wireless communication network architecture, i.e., a number of the electronic devices of the wireless communication network system is more, a broadcast storm may be formed and lead to the decrease of the communication efficiency.

To sum up the foregoing descriptions, the most important goal for now is to provide a broadcasting communication system that may inhibit a broadcast storm.

### SUMMARY OF THE INVENTION

The present invention is directed to provide a broadcasting communication system, a broadcasting relay device and a broadcasting relay method that may utilize a broadcasting relay device to receive a first broadcast packet from a first communication group to broadcast a second broadcast packet to a second communication group, wherein the second broadcast packet comprises a broadcast data of the first broadcast packet. Therefore, a plurality of first electronic devices of the first communication group and a plurality of second electronic devices of the second communication group that are communicatively isolated from each other may establish the communication connection through the broadcasting relay device, and a broadcast storm may be inhibited.

A broadcasting communication system of one embodiment of the present invention includes a plurality of first electronic devices, a plurality of second electronic devices and at least one broadcasting relay device. The plurality of first electronic devices is communicatively connected to each other with a first wireless communication protocol to form a first communication group. The plurality of second electronic devices is communicatively connected to each other with a second wireless communication protocol to form a second communication group, wherein the plurality of first electronic devices and the plurality of second electronic devices are communicatively isolated. The broadcasting relay device includes a communication unit and a processing unit. The communication unit is communicatively connected to the first communication group and the second communication group with the first wireless communication protocol and the second wireless communication protocol respectively. The processing unit is electrically connected to the communication unit, and the processing unit receives a first broadcast packet from the first communication group and broadcasts a second broadcast packet to the second communication group, wherein the second broadcast packet comprises a broadcast data of the first broadcast packet.

A broadcasting relay device of another embodiment of the present invention constitutes a broadcasting communication system together with a plurality of first electronic devices and a plurality of second electronic devices. The plurality of first electronic devices is communicatively connected to each other with a first wireless communication protocol to form a first communication group. The plurality of second electronic devices is communicatively connected to each other with a second wireless communication protocol to form a second communication group, and the plurality of first electronic devices and the plurality of second electronic devices are communicatively isolated. The broadcasting relay device comprises a communication unit and a processing unit. The communication unit is communicatively connected to the first communication group and the second communication group with the first wireless communication protocol and the second wireless communication protocol respectively. The processing unit is electrically connected to the communication unit, and the processing unit receives a first broadcast packet from the first communication group and broadcasts a second broadcast packet to the second communication group, wherein the second broadcast packet comprises a broadcast data of the first broadcast packet.

A broadcasting relay method of yet one embodiment of the present invention comprises: providing at least one broadcasting relay device communicatively connected to a first communication group and a second communication group with a first wireless communication protocol and a second wireless communication protocol respectively, wherein the first communication group includes a plurality of first electronic devices, the second communication group includes a plurality of second electronic devices, and the plurality of first electronic devices and the plurality of second electronic devices are communicatively isolated; receiving a first broadcast packet from the first communication group with the broadcasting relay device; and broadcasting a second broadcast packet to the second communication group with the broadcasting relay device, wherein the second broadcast packet comprises a broadcast data of the first broadcast packet.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

FIG. 1 is a schematic view showing a broadcasting communication system of one embodiment of the present invention.

FIG. 2 is a schematic view showing a broadcasting relay device of one embodiment of the present invention.

FIG. 3 is a schematic view showing a first communication group and a second communication group of one embodiment of the present invention.

FIG. 4 is a schematic view showing a first communication group and a second communication group of another embodiment of the present invention.

FIG. 5 is a schematic view showing a broadcasting communication system of one embodiment of the present invention.

FIG. 6 is a schematic view showing a broadcasting communication system of another embodiment of the present invention.

### DESCRIPTION OF THE PREFERRED EMBODIMENT

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

A traditional large wireless network system sets the overall network architecture as a single communication group, and broadcasts many broadcast packets to all the electronic devices within the communication group. When a number of the electronic devices within the communication group is too large, the broadcast packets may have the signal collision easily and a broadcast storm may be formed, which may result in that the communication efficiency may be decreased and the communication network may be paralyzed.

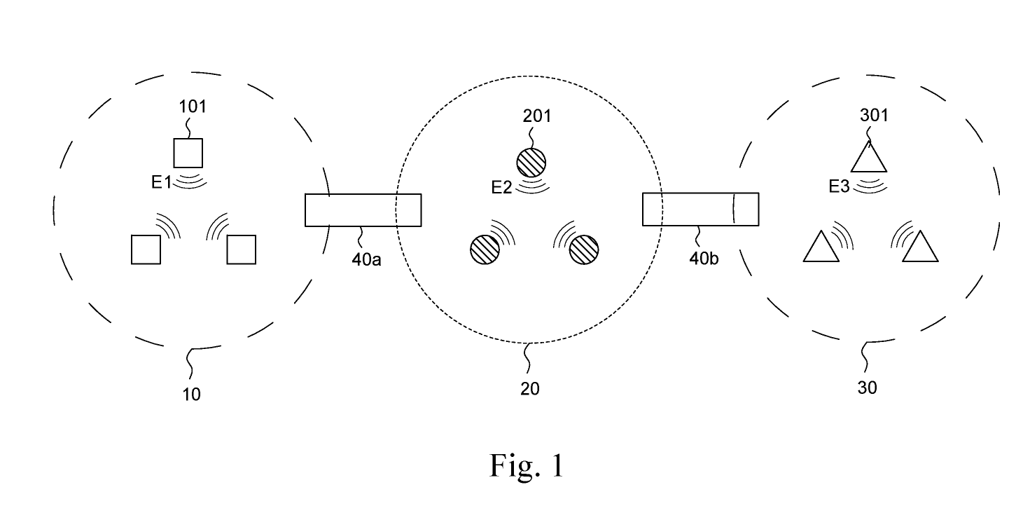

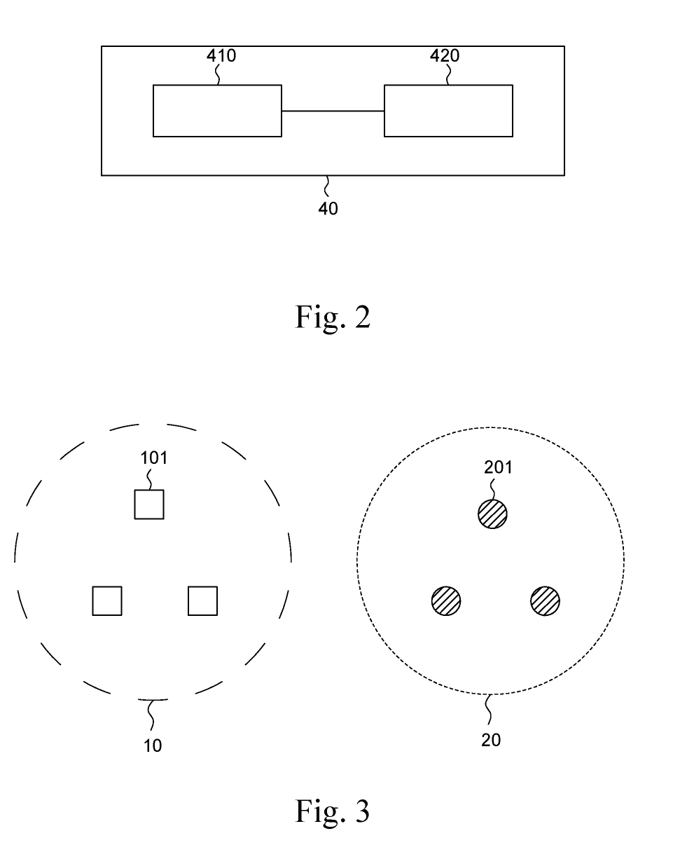

The present invention establishes a large broadcasting communication system through a broadcasting relay device that is communicatively connected to multiple communication groups that are communicatively isolated from each other, so as to inhibit the overall number of the broadcast packets. The meaning of the above-mentioned “communicatively isolated” is described later. Referring to FIG. 1 and FIG. 2 together, a broadcasting communication system of one embodiment of the present invention includes a plurality of first electronic devices 101, a plurality of second electronic devices 201, a plurality of third electronic devices 301 and a plurality of broadcasting relay devices 40a, 40b.

The plurality of first electronic devices 101 is communicatively connected to each other with a first wireless communication protocol to form a first communication group 10. For example, the first wireless communication protocol may adopt the wireless communication protocol, such as the Zigbee (IEEE 802.15.4), Bluetooth (IEEE 802.15.1) or WLAN (IEEE 802.11), etc., which is not a limitation. The plurality of second electronic devices 201 is communicatively connected to each other with a second wireless communication protocol to form a second communication group 20. The plurality of third electronic devices 301 is communicatively connected to each other with a third wireless communication protocol to form a third communication group 30. Also, the second wireless communication protocol and the third wireless communication protocol may adopt the above-mentioned wireless communication protocol as well, which is not described again here. Additionally, the plurality of first electronic devices 101 of the first communication group 10, the plurality of second electronic devices 201 of the second communication group 20 and the plurality of third electronic devices 301 of the third communication group 30 are communicatively isolated from each other, so that the number of the multiple electronic devices within each communication group may be controlled within a small range, so as to avoid producing too many broadcast packets within each communication group. It is needed to be explained that the broadcasting communication system may include multiple communication groups, and the three communication groups that are communicatively isolated from each other and described in this embodiment are only for illustrative explanation, and may not be used to limit the number of the multiple communication groups of the present invention or the connection relationship thereof.

The meaning of the “communicatively isolated” is described with the following related embodiments. Referring to FIG. 3, in one embodiment, although the first wireless communication protocol of the first communication group 10 and the second wireless communication protocol of the second communication group 20 are the same, the first communication group 10 and the second communication group 20 are isolated from each other in the space and may not communicate to each other directly due to the too far transmission distance, i.e., communicatively isolated from each other. Therefore, a first broadcast packet E1 of the first communication group 10 may not be broadcasted to the second communication group 20. Also, the first broadcast packet E1 of the first communication group 10 may not be broadcasted to the third communication group 30, as shown in FIG. 1. In other words, when a first electronic device 101 belonging to the first communication group 10 is at the space position of the second communication group 20, the first electronic device 101 may not communicate with other first electronic devices 101 of the first communication group 10.

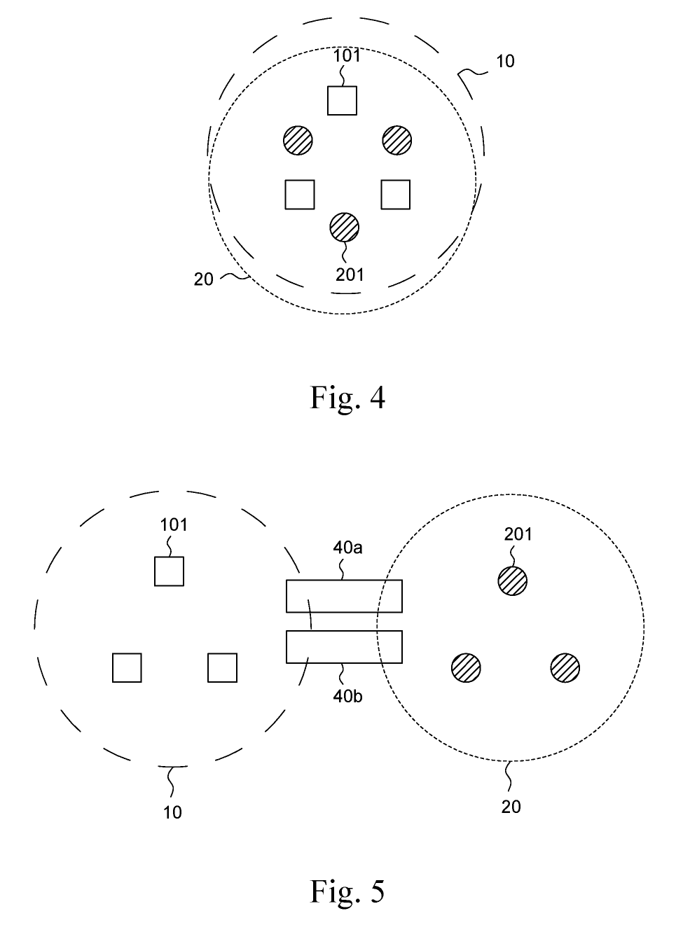

Referring to FIG. 4, in one embodiment, although the first wireless communication protocol of the first communication group 10 and the second wireless communication protocol of the second communication group 20 are the same, each communication group uses different broadcasting communication methods respectively. For example, in the ZigBee communication protocol, the first communication group 10 and the second communication group 20 are communication groups that are managed by different coordinators respectively. Therefore, the first electronic devices 101 and the second electronic devices 202 that respectively belong to the first communication group 10 and the second communication group 20 are communicatively isolated from each other.

Referring to FIG. 4, in another embodiment, the first wireless communication protocol of the first communication group 10 and the second wireless communication protocol of the second communication group 20 are different. Although the first communication group 10 and the second communication group 20 are disposed in the same space, each communication group respectively uses a different broadcasting communication method, e.g., different identification codes, different frequencies, or different modulation modes, and therefore, the multiple communication groups are communicatively isolated from each other. Therefore, a first broadcast packet E1 of the first communication group 10 may not be broadcasted to the second communication group 20, and the first electronic devices 101 and the second electronic devices 202 that respectively belong to the first communication group 10 and the second communication group 20 are communicatively isolated from each other.

Continued to refer to FIG. 1 and FIG. 2, the present invention utilizes at least one broadcasting relay device 40, 40a, 40b, which establishes the communication connections with multiple communication groups 10, 20, 30 that are communicatively isolated from each other through a communication unit 410 and determines whether or how a broadcast packet received from a communication group at one end is broadcasted to the other wireless communication group at the other end through a processing unit 420, so as to inhibit the overall number of the broadcast packets, avoid the occurrence of the broadcast storm, reduce the installation cost of the broadcasting communication system and increase the network stability. For example, referring to FIG. 2, the broadcasting relay device 40 includes a communication unit 410 and a processing unit 420. The communication unit 410 is communicatively connected to the first communication group 10 and the second communication group 20 with the first wireless communication protocol and the second wireless communication protocol respectively. The processing unit 420 is electrically connected to the communication unit 410, and the processing unit 420 receives a first broadcast packet E1 from the first communication group 10 and then broadcasts a second broadcast packet E2 to the second communication group 20, wherein the second broadcast packet E2 comprises a broadcast data of the first broadcast packet E1.

Referring to FIG. 5, in one embodiment, the first communication group 10 and the second communication group 20 are communicatively isolated from each other due to the space distance, and the present invention establishes a broadcasting communication system through the communication unit of at least one broadcasting relay device 40a, 40b that establishes the communication connections with the first communication group 10 and the second communication group 20 with the first wireless communication protocol and the second wireless communication protocol respectively. It may be understood that this embodiment adopts multiple broadcasting relay devices 40a, 40b to increase the network connection paths to improve the communication reliability, and the above network architecture may be realized by only using a single broadcasting relay device as well, which is not a limitation. In one embodiment, the first wireless communication protocol and the second wireless communication protocol are the same. For example, the first communication group 10 and the second communication group 20 both adopt the Zigbee communication protocol, so the processing unit 420 may receive the first broadcast packet E1 from the first communication group 10 without performing a packet format conversion and broadcast it to the second communication group 20. In another embodiment, the first wireless communication protocol and the second wireless communication protocol are different, so the processing unit 420 transforms the first broadcast packet E1 complied with the first wireless communication protocol into the second broadcast packet E2 complied with the second wireless communication protocol, wherein the second broadcast packet E2 comprises a broadcast data of the first broadcast packet E1. For example, the first communication group 10 adopts the Zigbee communication protocol, and the second communication group 20 adopts the Bluetooth communication protocol. After the processing unit 420 receives the first broadcast packet E1 complied with the Zigbee communication protocol, the processing unit 420 transforms it into the second broadcast packet E2 complied with the Bluetooth communication protocol, and broadcasts the second broadcast packet E2 to the second communication group 20.

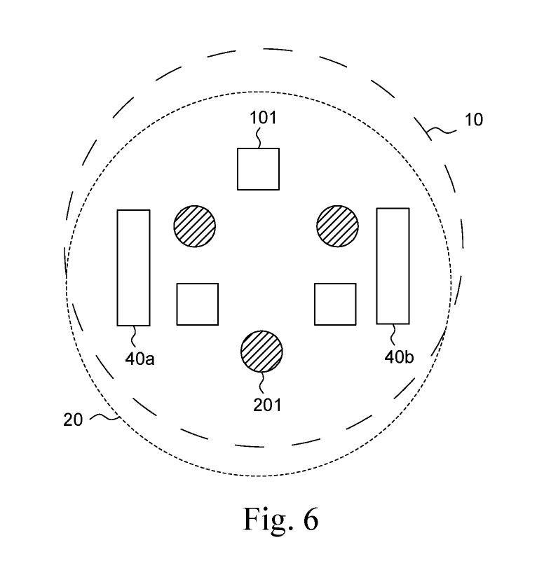

Referring to FIG. 6, in one embodiment, the first communication group 10 and the second communication group 20 adopt the same wireless communication protocol, but the first communication group 10 and the second communication group 20 are managed by different coordinators respectively or the first wireless communication protocol of the first communication group 10 and the second wireless communication protocol of the second communication group 20 are different, which may result in that the first communication group 10 and the second communication group 20 are communicatively isolated from each other. In the same way, through at least one broadcasting relay device 40a, 40b that establishes the communication connections with the first communication group 10 and the second communication group 20 respectively, a broadcasting communication system may be established. Based on this architecture, the processing unit of the broadcasting relay device 40a, 40b may broadcast the first broadcast packet E1 from the first communication group 10 to the second communication group 20.

Referring to FIG. 2 and FIG. 5 together, the following descriptions describe that the control unit 420 of the broadcasting relay device 40a determines whether or how the first broadcast packet E1 from the first communication group 10 is broadcasted. In one embodiment, the control unit 420 may determine whether the second broadcast packet E2 has ever been broadcasted to the second communication group 20 in accordance with logics, and then restrict the times that the second broadcast packet E2 is broadcasted to the second communication group 20. That is, before the second broadcast packet E2 is broadcasted by the broadcasting relay device 40a, the broadcasting relay device 40a may determine whether the second broadcast packet E2 will be broadcasted, so as to control the broadcast times thereof. For example, when the broadcasting relay device 40a has received the first broadcast packet E1 of the first communication group 10 and broadcasted the second broadcast packet E2 to the second communication group 20, this broadcasting relay device 40a will inform another broadcasting relay device 40b of this course record. Therefore, after the another broadcasting relay device 40b receives the first broadcast packet E1 of the first communication group 10, it will not broadcast the second broadcast packet E2 to the second communication group 20 again, which is not a limitation. In another embodiment, the control unit of the broadcasting relay device 40a may delay a delay time and then broadcast the second broadcast packet E2 to the second communication group 20. It may be understood that the delay time of the broadcasting relay device may be adjusted according to the use of the broadcasting communication system. For example, in a building, if the second communication group includes multiple lighting devices, then the delay time of the broadcasting relay device may be less than 10 seconds. Or, in a store, if the second communication group includes multiple electronic tags, then the delay time of the broadcasting relay device may be less than 100 seconds. Or, in a farm, if the second communication group includes multiple electronic sensors, then the delay time of the broadcasting relay device may be less than 600 seconds. Thus, the problem of the broadcast packet collision within the first communication group or the second communication group may be avoided. Those skilled in the art may modify and change, and may not be limited to this.

Continued to refer to FIG. 1, a broadcasting relay method of another embodiment of the present invention is described below. First, at least one broadcasting relay device 40a is provided, which is communicatively connected to a first communication group 10 and a second communication group 20 with a first wireless communication protocol and a second wireless communication protocol respectively. In addition, the first communication group 10 includes a plurality of first electronic devices 101, the second communication group 20 includes a plurality of second electronic devices 201, and the plurality of first electronic devices 101 and the plurality of second electronic devices 202 are communicatively isolated.

Second, the broadcasting relay device 40a receives a first broadcast packet E1 broadcasted by the first communication group. In one embodiment, the broadcasting relay device 40a transforms the first broadcast packet E1 complied with the first wireless communication protocol into the second broadcast packet E2 complied with the second wireless communication protocol. The related embodiments are as described above and omitted here.

Then, the broadcasting relay device 40a broadcasts the second broadcast packet E2 to the second communication group 20, wherein the second broadcast packet E2 comprises a broadcast data of the first broadcast packet E1. In one embodiment, the broadcasting relay device 40a may determine whether or how a broadcast packet received from a communication group at one end is broadcasted to the other wireless communication group at the other end, so as to inhibit the overall number of the broadcast packets, avoid the occurrence of the broadcast storm, reduce the installation cost of the broadcasting communication system and increase the network stability. The related embodiments are as described above and omitted here.

To sum up the foregoing descriptions, the present invention establishes a broadcasting communication system through a broadcasting relay device that is communicatively connected to multiple communication groups that are communicatively isolated from each other. In addition, the broadcasting relay device may determine whether a broadcast packet received from a communication group at one end is broadcasted or broadcasted with a delay time to the other communication group at the other end, so as to inhibit the overall number of the broadcast packets, avoid the occurrence of the broadcast storm, reduce the installation cost of the broadcasting communication system and increase the network stability.

What is claimed is:

1. A broadcasting communication system comprising:
a plurality of first electronic devices communicatively connected to each other with a first wireless communication protocol to form a first communication group;
a plurality of second electronic devices communicatively connected to each other with a second wireless communication protocol to form a second communication group, wherein the plurality of first electronic devices and the plurality of second electronic devices are communicatively isolated; and
at least one broadcasting relay device comprising:
a communication unit communicatively connected to the first communication group and the second communication group with the first wireless communication protocol and the second wireless communication protocol respectively; and
a processing unit electrically connected to the communication unit to receive a first broadcast packet from the first communication group and broadcast a second broadcast packet to the second communication group, wherein the second broadcast packet comprises a broadcast data of the first broadcast packet.

2. The broadcasting communication system according to claim 1, wherein the first wireless communication protocol and the second wireless communication protocol are the same.

3. The broadcasting communication system according to claim 1, wherein the first wireless communication protocol and the second wireless communication protocol are different, and the processing unit of the broadcasting relay device transforms the first broadcast packet complied with the first wireless communication protocol into the second broadcast packet complied with the second wireless communication protocol.

4. The broadcasting communication system according to claim 1, wherein the processing unit determines whether the second broadcast packet is broadcasted.

5. The broadcasting communication system according to claim 1, wherein the processing unit delays the broadcast of the second broadcast packet.

6. The broadcasting communication system according to claim 1, wherein the first wireless communication protocol and the second wireless communication protocol include at least one of the Zigbee (IEEE 802.15.4), Bluetooth (IEEE 802.15.1) and WLAN (IEEE 802.11).

7. The broadcasting communication system according to claim 1, wherein the broadcasting relay device includes a plurality of broadcasting relay devices.

8. A broadcasting relay device constituting a broadcasting communication system together with a plurality of first electronic devices and a plurality of second electronic devices, the plurality of first electronic devices being communicatively connected to each other with a first wireless communication protocol to form a first communication group, the plurality of second electronic devices being communicatively connected to each other with a second wireless communication protocol to form a second communication group, the plurality of first electronic devices and the plurality of second electronic devices being communicatively isolated, the broadcasting relay device comprising:
a communication unit communicatively connected to the first communication group and the second communication group with the first wireless communication protocol and the second wireless communication protocol respectively; and
a processing unit electrically connected to the communication unit to receive a first broadcast packet from the first communication group and broadcast a second broadcast packet to the second communication group, wherein the second broadcast packet comprises a broadcast data of the first broadcast packet.

9. The broadcasting relay device according to claim 8, wherein the first wireless communication protocol and the second wireless communication protocol are the same.

10. The broadcasting relay device according to claim 8, wherein the first wireless communication protocol and the second wireless communication protocol are different, and the processing unit transforms the first broadcast packet complied with the first wireless communication protocol into the second broadcast packet complied with the second wireless communication protocol.

11. The broadcasting relay device according to claim 8, wherein the processing unit determines whether the second broadcast packet is broadcasted.

12. The broadcasting relay device according to claim 8, wherein the processing unit delays the broadcast of the second broadcast packet.

13. The broadcasting relay device according to claim 8, wherein the first wireless communication protocol and the second wireless communication protocol include at least one of the Zigbee (IEEE 802.15.4), Bluetooth (IEEE 802.15.1) and WLAN (IEEE 802.11).

14. A broadcasting relay method comprising:
providing at least one broadcasting relay device communicatively connected to a first communication group and a second communication group with a first wireless communication protocol and a second wireless communication protocol respectively, wherein the first communication group includes a plurality of first electronic devices, the second communication group includes a plurality of second electronic devices, and the plurality of first electronic devices and the plurality of second electronic devices are communicatively isolated;
receiving a first broadcast packet from the first communication group with the broadcasting relay device; and
broadcasting a second broadcast packet to the second communication group with the broadcasting relay device, wherein the second broadcast packet comprises a broadcast data of the first broadcast packet.

15. The broadcasting relay method according to claim 14, wherein the first wireless communication protocol and the second wireless communication protocol are the same.

16. The broadcasting relay method according to claim 14, wherein the first wireless communication protocol and the second wireless communication protocol are different, and the broadcasting relay method further comprises:
transforming the first broadcast packet complied with the first wireless communication protocol into the second broadcast packet complied with the second wireless communication protocol with the broadcasting relay device.

17. The broadcasting relay method according to claim 14, wherein before the step of broadcasting the second broadcast packet, the broadcasting relay method further comprises: determining whether the second broadcast packet is broadcasted with the broadcasting relay device.

18. The broadcasting relay method according to claim 14, wherein the step of broadcasting the second broadcast packet further comprises: delaying the broadcast of the second broadcast packet with a delay time.

19. The broadcasting relay method according to claim 14, wherein the first wireless communication protocol and the second wireless communication protocol include at least one of the Zigbee (IEEE 802.15.4), Bluetooth (IEEE 802.15.1) and WLAN (IEEE 802.11).
